(19) United States
(12) Patent Application Publication
(10) Pub. No.: US 2017/0091348 A1
(43) Pub. Date: Mar. 30, 2017

(54) INTELLIGENT SUGGESTIONS FOR RACK LAYOUT SETUP

(71) Applicant: International Business Machines Corporation, Armonk, NY (US)

(72) Inventors: Emmanuel Barajas Gonzalez, Guadalajara (MX); Shaun E. Harrington, Sahuarita, AZ (US); Benjamin K. Rawlins, Tucson, AZ (US)

(21) Appl. No.: 14/864,969

(22) Filed: Sep. 25, 2015

(51) Int. Cl. G06F 17/50

(52) U.S. Cl. CPC G06F 17/5004

(57) ABSTRACT

A method for generating a rack configuration in a data center facility includes reading physical parameters of the data center facility, reading equipment parameters of a computer equipment in the data center facility, reading user-specific parameters comprising physical characteristics of a user, and generating an optimal rack configuration for the data center facility based on the physical parameters, the equipment parameters, and the user-specific parameters.

### BACKGROUND

The present invention generally relates to information technology (IT) facility management, and more particularly, to a method for providing intelligent suggestions for rack layout setup.

A data center is a facility where an organization's IT operations and equipment is centralized, and where its data is stored, managed, and disseminated. Traditional concepts related to daily operations in a data center facility (also referred to as IT laboratory) are changing due to the advent of new technologies that aim to simplify and ease the tasks related to this area. New methodologies including software development methods that stress communication, collaboration, integration, automation, and measurement of cooperation between software developers and other IT professionals (e.g., DevOps) are accelerating the whole development cycle and allowing the deployment of fully operational environments within minutes. This may result in a higher level of comfort for developers and testers, and allows them to focus on tasks with more added value.

Another key player in the whole IT cycle is the personnel in charge of setting up computer racks (e.g., server racks) within the data center facility. While the use of state-of-the-art technologies have facilitated daily work functions for developers, testers and managers, manual work related to rack setup remains the same.

### SUMMARY

According to an embodiment of the present disclosure, a method for generating a rack configuration in a data center facility may include reading physical parameters of the data center facility, reading equipment parameters of a computer equipment in the data center facility, reading user-specific parameters including physical characteristics of a user, and generating an optimal rack configuration for the data center facility based on the physical parameters, the equipment parameters, and the user-specific parameters.

According to another embodiment of the present disclosure, a computer system for generating a rack layout setup in a data center facility may include one or more processors, one or more computer-readable memories, one or more computer-readable tangible storage devices, and program instructions stored on at least one of the one or more storage devices for execution by at least one of the one or more processors via at least one of the one or more memories, the computer system may be capable of performing a method including reading physical parameters of the data center facility, reading equipment parameters of a computer equipment in the data center facility, reading user-specific parameters including physical characteristics of a user, and generating an optimal rack configuration for the data center facility based on the physical parameters, the equipment parameters, and the user-specific parameters.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 is a flowchart depicting processing steps for generating a rack layout, according to an embodiment of the present disclosure;

FIG. 3 is a block diagram of internal and external components of computers and servers depicted in FIG. 1, according to an embodiment of the present disclosure;

FIG. 4 is a block diagram of an illustrative cloud computing environment including the computer system depicted in FIG. 1, according to an embodiment of the present disclosure; and

FIG. 5 is a block diagram of functional layers of the illustrative cloud computing environment of FIG. 4, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Centralized data centers for computer, communications and other electronic equipment typically contain numerous racks of equipment. In recent years, for instance, the wide spread use of the Internet has caused a significant increase in the density of computing equipment existing in data center facilities, and particularly in large-scale data centers. This may require automated tools for planning and designing an efficient arrangement for the racks of computing equipment.

As mentioned above, despite the advent of new technologies in the IT field, manual work related to rack setup within IT facilities remains the same. The manual work related to rack setup may typically include activities such as, for example, determination of laboratory size, location of power outlets, rack sizes and availability, heating and/or cooling constraints, etc.

While some administrators and testers have created customized control systems that allow them to identify individual systems and plan for future growth in a given IT facility, any work done outside their scope and knowledge usually results in computing equipment (e.g., server computers) being installed in a rack without any consideration of the actual work that may be performed in that particular rack or the person that may be doing the work. For example, a short person may end up using a ladder very frequently to work on a particular server computer that was installed in the top portion of a rack because the installation was performed considering only the location of empty slots in the rack, disregarding other important factors such as the physical characteristics of the user.

Embodiments of the present disclosure may provide a method, system, and computer program product for setting a data center or IT laboratory environment in an automated fashion. As such, rack configuration and distribution within IT facilities may be quickly and efficiently performed while integrating requirements for future users. The proposed method may take into account numerous parameters for suggesting a rack layout including, for example, cable lengths, future use of computing equipment, equipment positioning within racks, and physical characteristics of users, such that the end product is an ideal rack setup tailored to the work to be performed and the people (users) performing it. This may allow a laboratory environment to be established in an orderly and user-friendly fashion while ensuring that users know substantially all the design parameters for setting up the facility well ahead of time. In addition, by knowing a data center specific parameters, heating, cooling, and power requirements may be pre-determined without a single person visiting the environment to be.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

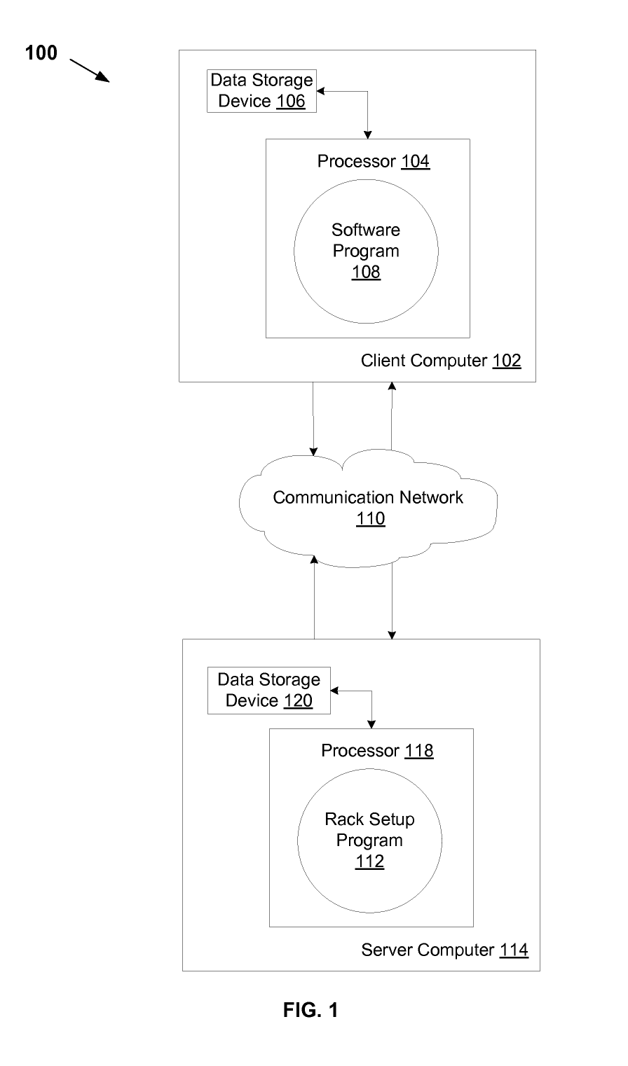

Referring now to FIG. 1, an exemplary networked computer environment 100 is depicted, according to an embodiment of the present disclosure. The networked computer environment 100 may include a client computer 102 with a processor 104 and a data storage device 106 that is enabled to run a software program 108. The networked computer environment 100 may also include a server computer 114 and a communication network 110. The networked computer environment 100 may include a plurality of client computers 102 and server computers 114, only one of which is shown. The communication network 110 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

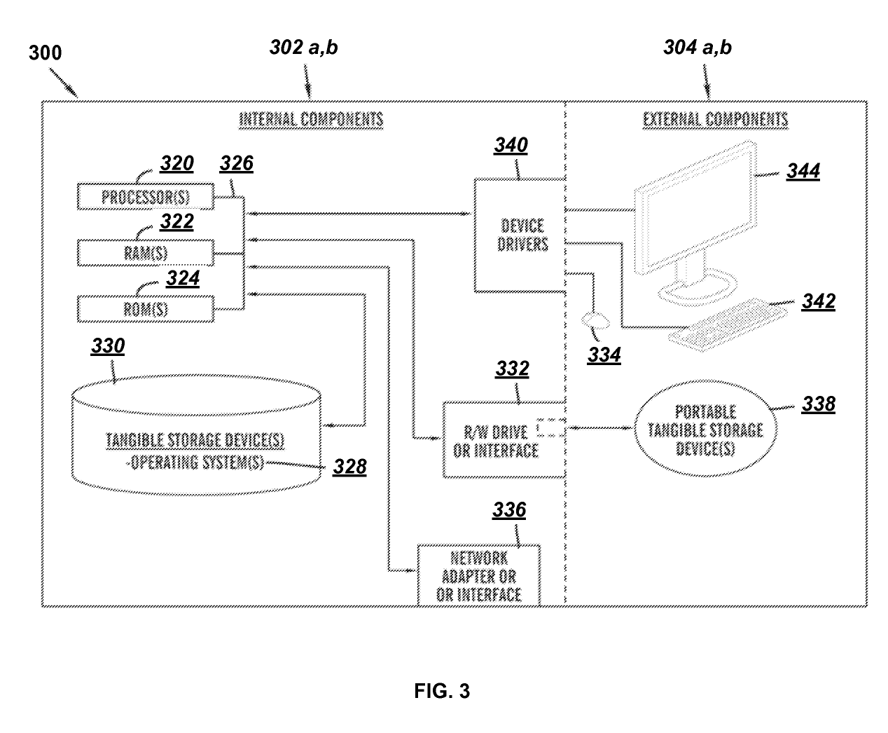

The client computer 102 may communicate with a rack setup program 112 running on server computer 114 via the communication network 110. The communication network 110 may include connections, such as wire, wireless communication links, or fiber optic cables. As will be discussed with reference to FIG. 3, server computer 114 may include internal components 302a and external components 304a, respectively, and client computer 102 may include internal components 302b and external components 304b, respectively. Client computer 102 may be, for example, a mobile device, a telephone, a personal digital assistant, a netbook, a laptop computer, a tablet computer, a desktop computer, or any type of computing devices capable of accessing a network.

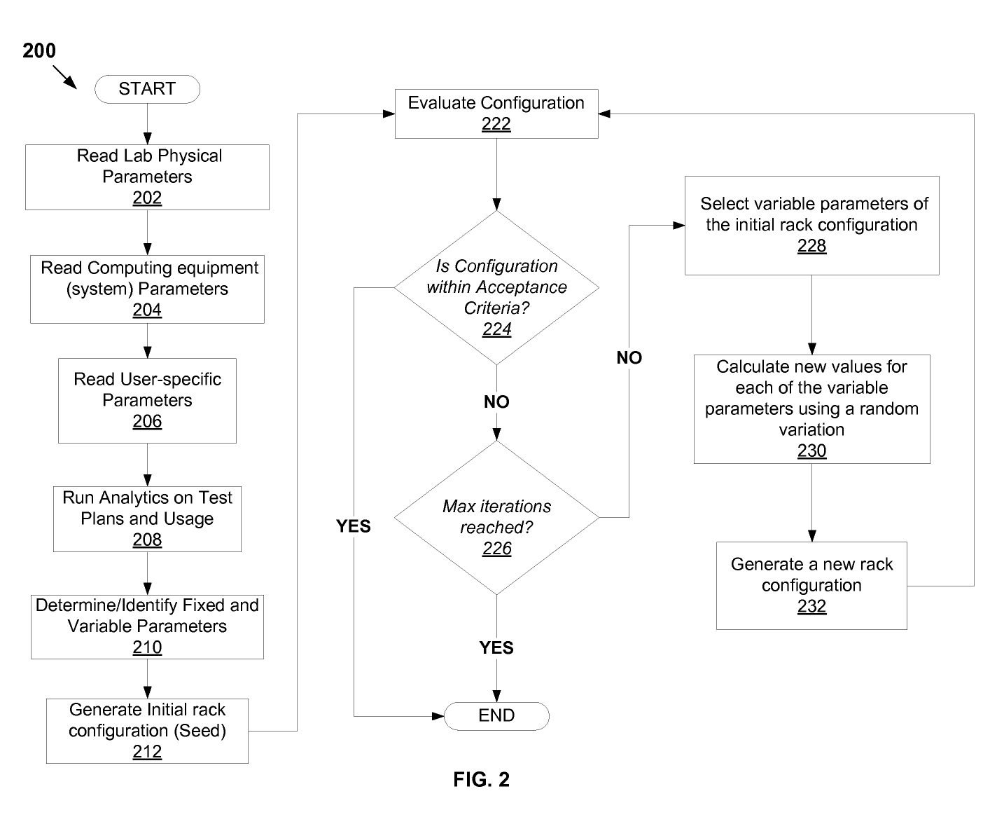

Referring now to FIG. 2, a flowchart 200 illustrating the steps of a method for providing intelligent suggestions for rack layout and setup in a data center is shown, according to an embodiment of the present disclosure.

In the depicted embodiment, multiple sources of information may be used in order to cover a wide range of computer equipment and settings that may be established within a determined data center. Different information parameters may be defined and inputted by a user prior to setting up the data center facility as will be described in detailed below.

At 202, physical parameters corresponding to a specific data center (not shown) currently under study are read by the rack setup program 112 (FIG. 1). In one embodiment, the physical parameters may be defined and inputted by a user of the data center facility. In another embodiment, the physical parameters may already exist or may be taken from previous runs of the rack setup program 112 (FIG. 1). The physical parameters of the data center may include, but are not limited to, facility size and dimensions, location of power outlets within the data center, power allocation, heating/cooling constraints, floor configuration (raised or non-raised), network availability, weight limits, etc.

The process continues at 204 where parameters corresponding to the computing equipment (system) to be positioned in the racks are read by the rack setup program 112 (FIG. 1). In one embodiment, computing equipment parameters may be defined and inputted by a user of the data center facility. In another embodiment, the computing equipment parameters may already exist in the rack setup program 112 (FIG. 1) from previous runs. The computing equipment parameters may include, but are not limited to, equipment (e.g., servers) size and weight, rack size and availability, power requirements, network requirements, etc.

After reading the data center physical parameters and the computing equipment parameters, a plurality of user-specific parameters are defined at 206. The user-specific parameters are read by the rack setup program 112 (FIG. 1). The user-specific parameters generally include, for example, physical characteristics of one or more users (e.g., height and/or weight), strength capacity, and/or handicap accessibility.

Next, the rack setup program 112 (FIG. 1) runs an analytic algorithm at 208 on a plurality of test plans including a history of rack configurations. As may be known by those skilled in the art, test plans generally include a scheme describing analysis scope and activities for formally testing any software product in a project.

It should be noted that the analytics part of the proposed method may be performed using a variety of software packages and may depend, in some embodiments, on the format of the test plans. For example, in one embodiment in which the test plans are stored in a structured way, a script written in a programming language such as R language may probably be able to determine the frequency distribution of the positions of a certain computing equipment (system) over time. For example, in another embodiment in which the test plans are stored in plain text or other format, a set of MapReduce jobs may probably be needed to perform the analysis and determine the required values (e.g., most frequently used position within racks, average user height, most frequently used system over all the test plans, etc.)

Prior to running the analytics algorithm, usage assumptions are also defined in the rack setup program 112 (FIG. 1), including, for example, potential testing and test plan necessities, user accessibility requirements (keyboard, mouse, etc.), and future usage particulars (possible facility expansions, etc.). The analytic algorithm may be capable of analyzed content from previous test plans in order to predict the best arrangement for the computing equipment within the racks.

For example, if analytics results show that a first server computer located within a lower portion of a rack was frequently accessed in previous test plans, then in the proposed layout the location of the first server computer remains the same within that rack. However, if a second server computer located also within the lower portion of the rack has not been accessed in numerous test plans, the location of the second computer may change in the proposed rack layout.

At 210, system variables/parameters are determined based on the analytics results. The determined variables depend on the usage trends obtained from the analysis of previous test plans. For example, in one embodiment, the determined variables may include: position of a computing equipment within a rack and/or the relocation of such computing equipment from one rack to another rack. This may allow identification of those parameters that may remain fixed or unchanging within the final layout (hereinafter “fixed parameters”) and those that may be changed (hereinafter “variable parameters”) to satisfy certain requirements. Then, an initial rack layout setup or configuration (seed) is obtained at 212. The initial rack configuration is consequently evaluated at 222. If after evaluation the initial rack configuration at 224 is within an acceptance criteria (for instance, the minimum number of servers in a position that is suitable for the user and does not contradict the “fixed” parameters has been reached), the process ends and the initial rack configuration is the optimal rack configuration to be implemented in the data center facility. If the initial rack configuration at 224 is not within the acceptance criteria and the maximum number of iterations has been reached at 226, the process ends. In this case, the configuration that is closer to the optimal distribution is returned, however if its evaluation is below a previously defined threshold (e.g., only 3 out of 7 required parameters are met) then a notification is sent to the user.

It should be noted that the maximum number of iterations at 226 may be determined by the user before executing the process. It may generally depend on the time the user is willing to wait for the process to run before it timeouts.

If the initial rack configuration at 224 is not within the acceptance criteria but the maximum number of iterations has not been reached, a new rack configuration is generated by changing one or more of the variable parameters in the initial configuration. First, the variable parameters of the initial rack configuration are selected at 228. In some embodiments, substantially all of the variable parameters of the initial rack configuration may be changed or adjusted in order to achieve an optimal rack configuration. At 230, new values for each of the selected variable parameters are calculated using a random variation. More specifically, the rack setup program 112 (FIG. 1) allows the user to change only those parameters in the system identified or set as variable parameters, the rack setup program 112 (FIG. 1) automatically prevents fixed parameters from being modified.

The process continues at 232 where a new rack configuration is generated and then evaluated at 222 as described above. The process repeats until a rack configuration that substantially satisfies all of the requirements is found within an acceptable number of iterations. As previously described, the determined fixed parameters may not change during the execution of the rack setup program 112 (FIG. 1), only the variable parameters may be adjusted in order to satisfy the acceptance criteria.

The described embodiments may provide a method for framing an optimal rack configuration. Configuration options may be generated by the rack setup program 112 (FIG. 1) and assessed against current information. The generated configuration may typically be assessed against two types of parameters, fixed parameters and variable parameters as described above. Fixed parameters may generally consist of a parameter that cannot be changed, such as the position of power outlets or the relative position of a server with respect to another server (for example, node0 is always below node1 in a cluster). Variable parameters may generally consist of those parameters or properties that can be changed within the environment.

As described above, the proposed method may begin by evaluating a plurality of candidate rack configurations (seeds) from which the ones that are closer to having the computing equipment (system) at the right positions within the rack, according to the fixed parameters, are selected. Finally, from the selected layouts, the rack setup program 112 (FIG. 1) may continue its evaluating process until finding an optimal configuration that may substantially satisfy all of the specified requirements. As such, embodiment of the present disclosure may provide an environment that is in tune with what exactly that environment is intended to be used for and who intends to use it.

Referring now to FIG. 3, a block diagram 300 of internal and external components of computers depicted in FIG. 1 is shown according to an embodiment of the present disclosure. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 302, 304 is representative of any electronic device capable of executing machine-readable program instructions. Data processing system 302, 304 may be representative of a smart phone, a computer system, PDA, or other electronic devices. Examples of computing systems, environments, and/or configurations that may represented by data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computer 102 (FIG. 1) and server computer 114 (FIG. 1) may include respective sets of internal components 302 a,b and external components 304 a,b illustrated in FIG. 3. Each of the sets of internal components 302 include one or more processors 320, one or more computer-readable RAMs 322 and one or more computer-readable ROMs 324 on one or more buses 326, and one or more operating systems 328 and one or more computer-readable tangible storage devices 330. The software program 108 in client computer 102 (FIG. 1) and the rack setup program 112 in the server computer 114 (FIG. 1) are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. Software programs, such as the first and second plurality of modules described above can be stored on one or more of the respective portable computer-readable tangible storage devices 338, read via the respective R/W drive or interface 332 and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 in client computer 102 (FIG. 1) and the rack setup program 112 in the server computer 114 (FIG. 1) can be downloaded to the client computer 102 (FIG. 1) and server computer 114 (FIG. 1) from an external computer via a network (for example, the Internet, a local area network or other, wide area network) and respective network adapters or interfaces 336. From the network adapters or interfaces 336, the software program 108 in client computer 102 (FIG. 1) and the rack setup program 112 in the server computer 114 (FIG. 1) are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342 and computer mouse 334. The device drivers 340, R/W drive or interface 332 and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

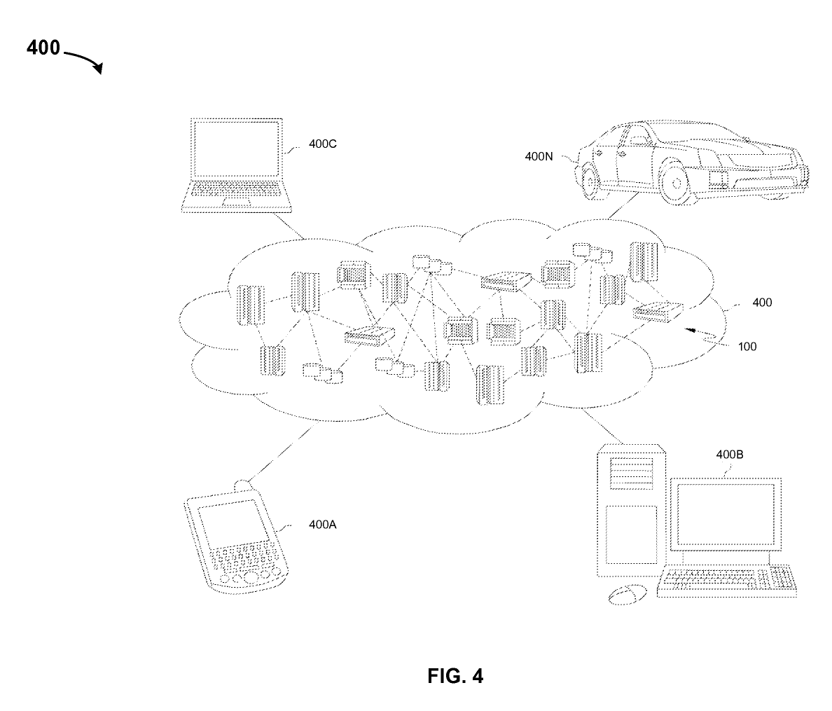

Referring now to FIG. 4, an illustrative cloud computing environment 400 is depicted. As shown, cloud computing environment 400 includes one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

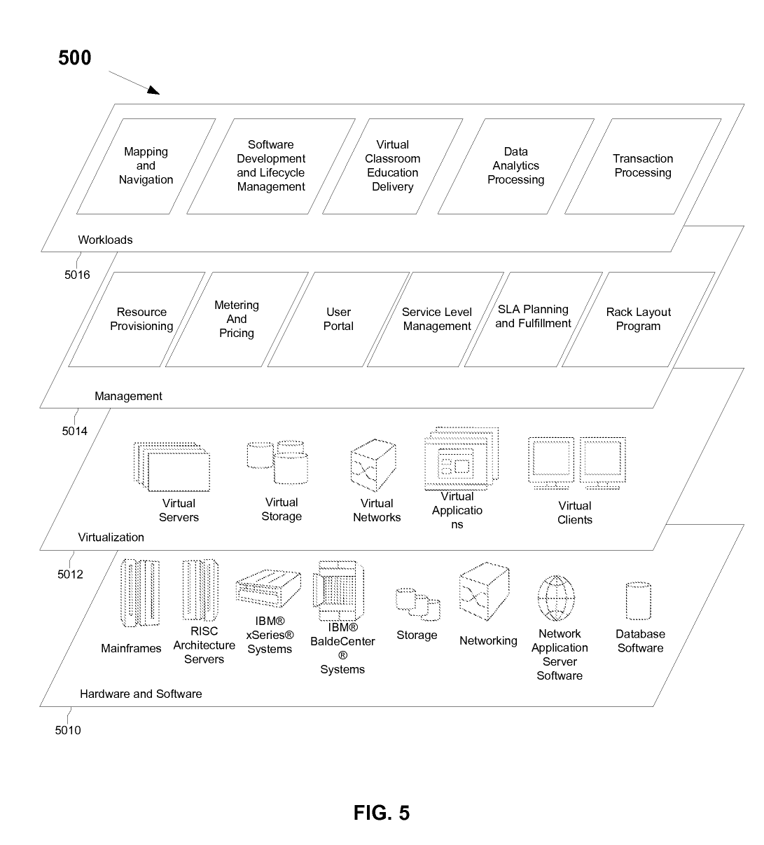

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 5010 includes hardware and software components. Examples of hardware components include: mainframes; RISC (Reduced Instruction Set Computer) architecture based servers; storage devices; networks and networking components. In some embodiments, software components include network application server software.

Virtualization layer 5012 provides an abstraction layer from which the following examples of virtual entities may be provided: virtual servers; virtual storage; virtual networks, including virtual private networks; virtual applications and operating systems; and virtual clients.

In one example, management layer 5014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A program for rack setup within an IT data center may provide intelligent suggestions for an ideal rack layout.

Workloads layer 5016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating a rack configuration in a data center facility, the method comprising:
reading physical parameters of the data center facility;
reading equipment parameters of a computer equipment in the data center facility;
reading user-specific parameters comprising physical characteristics of a user; and
generating an optimal rack configuration for the data center facility based on the physical parameters, the equipment parameters, and the user-specific parameters.

2. The method of claim 1, wherein generating the optimal rack configuration in the data center facility comprises:
adjusting one or more of the physical parameters, the equipment parameters, and the user-specific parameters.

3. The method of claim 1, wherein the physical parameters comprise size and dimensions of the data center facility, location of power outlets within the data center facility, power allocation, heating/cooling constraints, floor configuration, network availability, or weight limits.

4. The method of claim 1, wherein the equipment parameters comprise equipment size and weight, rack size and availability, power requirements, or network requirements.

5. The method of claim 1, wherein the physical characteristics of a user comprise height, weight, strength capacity, or handicap accessibility.

6. The method of claim 1, wherein generating the optimal rack configuration in the data center facility comprises:
determining existing data center parameters by running an analytics algorithm on an existing rack configuration of the data center facility; and
generating the optimal rack configuration in the data center facility based on the physical parameters, the equipment parameters, the user-specific parameters and the existing data center parameters.

7. The method of claim 1, wherein generating the optimal rack configuration in the data center facility comprises:
adjusting one or more of the physical parameters, the equipment parameters, the user-specific parameters, and the existing data center parameters.

8. A computer system for generating a rack configuration in a data center facility, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
reading physical parameters of the data center facility;
reading equipment parameters of a computer equipment in the data center facility;
reading user-specific parameters comprising physical characteristics of a user; and
generating an optimal rack configuration for the data center facility based on the physical parameters, the equipment parameters, and the user-specific parameters.

9. The computer system of claim 8, wherein generating the optimal rack configuration in the data center facility comprises:
adjusting one or more of the physical parameters, the equipment parameters, and the user-specific parameters.

10. The computer system of claim 8, wherein the physical parameters comprise size and dimensions of the data center facility, location of power outlets within the data center facility, power allocation, heating/cooling constraints, floor configuration, network availability, or weight limits.

11. The computer system of claim 8, wherein the equipment parameters comprise equipment size and weight, rack size and availability, power requirements, or network requirements.

12. The computer system of claim 8, wherein the physical characteristics of a user comprise height, weight, strength capacity, or handicap accessibility.

13. The computer system of claim 8, wherein generating the optimal rack configuration in the data center facility comprises:
determining existing data center parameters by running an analytics algorithm on an existing rack configuration of the data center facility; and
generating the optimal rack configuration in the data center facility based on the physical parameters, the equipment parameters, the user-specific parameters and the existing data center parameters.

14. The computer system of claim 8, wherein generating the optimal rack configuration in the data center facility comprises:
adjusting one or more of the physical parameters, the equipment parameters, the user-specific parameters, and the existing data center parameters.
